(19) United States
(12) Patent Application Publication
(10) Pub. No.: US 2026/0316629 A1
(43) Pub. Date: Oct. 15, 2026

(54) POWER CONVERSION SYSTEM STARTUP FOR VEHICLES

(71) Applicant: Mohamed Ahmed Kamel Ahmed, Birmingham, MI (US)

(72) Inventor: Mohamed Ahmed Kamel Ahmed, Birmingham, MI (US)

(73) Assignee: GM GLOBAL TECHNOLOGY OPERATIONS LLC, DETROIT, MI (US)

(21) Appl. No.: 19/177,861

(22) Filed: Apr. 14, 2025

(51) Int. Cl. B60L 58/22; B60L 15/00; H02M 3/335

(52) U.S. Cl. CPC B60L 58/22; B60L 15/007; H02M 3/33573; H02M 3/33576

(57) ABSTRACT

Examples described herein provide a method that includes providing a power converter circuit including a primary bridge having a first plurality of switches and a secondary bridge having a second plurality of switches. The method further includes disabling the secondary bridge of the power converter circuit by opening one or more the second plurality of switches. The method further includes regulating a voltage to a desired target until a steady state is reached. The method further includes, responsive to the steady state being reached, enabling the secondary bridge by closing the one or more of the second plurality of switches. The method further includes transferring power from the primary bridge to the secondary bridge without inrush current.

The subject disclosure relates to vehicles, and in particular to power conversion system startup for vehicles.

Modern vehicles (e.g., a car, a motorcycle, a boat, or any other type of automobile) may be equipped with one or more batteries to provide electrical power to various systems of the vehicle. For example, an electric vehicle may include one or more batteries to provide electrical power to one or more electric motors, which provide propulsion to the vehicle. This configuration of vehicle is referred to as a battery electric vehicle (BEV). Other types of vehicles may also be equipped with batteries, such as vehicles with combustion engines, hybrid-electric vehicles, and/or the like, including combinations and/or multiples thereof.

Many modern vehicles, especially hybrids and electric vehicles, use both high-voltage (HV) and low-voltage (LV) battery systems to power different components efficiently. The HV battery, typically ranging from substantially 200V to substantially 800V, is used to drive the electric motor and support energy-intensive functions, such as fast charging and regenerative braking. The LV battery, usually a substantially 12V or substantially 48V battery, powers vehicle electronics, such as lighting, infotainment, and safety features, ensuring reliable operation even when the HV system is inactive.

Vehicles may utilize an onboard charging module (OBCM) to charge a battery (e.g., the HV and/or LV battery) of the vehicle from an external source, such as the power grid. OBCMs are a type of power conversion system that manages the conversion of alternating current (AC) power from an external source into direct current (DC) power to charge the vehicle's high-voltage battery. They regulate charging speed, voltage, and current to ensure safe and efficient energy transfer while protecting the battery from overcharging or overheating. OBCMs often include power factor correction and communication interfaces to interact with charging stations and vehicle control systems. Advanced OBCMs support bidirectional charging, enabling vehicle-to-grid (V2G), vehicle-to-vehicle (V2V), vehicle-to-load (V2L), and/or vehicle-to-home (V2H) capabilities for enhanced energy management.

It is desirable to provide improved power conversion system startup for vehicles.

### SUMMARY

In one embodiment, a method is provided. The method includes providing a power converter circuit including a primary bridge having a first plurality of switches and a secondary bridge having a second plurality of switches. The method further includes disabling the secondary bridge of the power converter circuit by opening one or more the second plurality of switches. The method further includes regulating a voltage to a desired target until a steady state is reached. The method further includes, responsive to the steady state being reached, enabling the secondary bridge by closing the one or more of the second plurality of switches. The method further includes transferring power from the primary bridge to the secondary bridge without inrush current.

In addition to one or more of the features described herein, or as an alternative, further embodiments of the method may include that the primary bridge is a high voltage bridge that includes or is electrically connected to a high voltage battery.

In addition to one or more of the features described herein, or as an alternative, further embodiments of the method may include that the secondary bridge is a low voltage bridge that includes or is electrically connected to a low voltage battery.

In addition to one or more of the features described herein, or as an alternative, further embodiments of the method may include that the first plurality of switches includes four switches arranged in series.

In addition to one or more of the features described herein, or as an alternative, further embodiments of the method may include that the second plurality of switches includes four switches.

In addition to one or more of the features described herein, or as an alternative, further embodiments of the method may include that the power converter circuit includes a voltage sensor.

In addition to one or more of the features described herein, or as an alternative, further embodiments of the method may include that the power converter circuit includes a voltage sensor.

In addition to one or more of the features described herein, or as an alternative, further embodiments of the method may include adjusting a gate signal of one or more of the first plurality of switches or the second plurality of switches relative to a common control clock.

In addition to one or more of the features described herein, or as an alternative, further embodiments of the method may include that adjusting the gate signal includes adjusting a gate duration of the gate signal.

In addition to one or more of the features described herein, or as an alternative, further embodiments of the method may include that adjusting the gate signal includes adjusting a relative phase of the gate signal.

In addition to one or more of the features described herein, or as an alternative, further embodiments of the method may include controlling a transformer current of a transformer using a current sensor of the power converter circuit.

In addition to one or more of the features described herein, or as an alternative, further embodiments of the method may include controlling a transformer current of a transformer using a voltage sensor of the power converter circuit.

In addition to one or more of the features described herein, or as an alternative, further embodiments of the method may include regulating an effective voltage value of a transformer.

In another embodiment, a power converter circuit for a vehicle is provided. The power converter circuit includes a primary bridge having a first plurality of switches including a first switch, a second switch, a third switch, and a fourth switch. The power converter circuit further includes a high voltage battery electrically connected to the primary bridge. The power converter circuit further includes a secondary bridge having a second plurality of switches including a fifth switch, a sixth switch, a seventh switch, and an eight switch. The power converter circuit further includes a low voltage battery electrically connected to the secondary bridge. The power converter circuit further includes a transformer electrically connecting the primary bridge and the secondary bridge. The power converter circuit further includes a controller to selectively control the first plurality of switches and the second plurality of switches. The controller causes the secondary bridge to be enabled by causing one or more the second plurality of switches to open. The controller regulates a voltage to a desired target until a steady state is reached. The controller, responsive to the steady state being reached, causes the secondary bridge to be enabled by causing the one or more of the second plurality of switches to close.

The controller causes power to be transferred across the transformer from the primary bridge to the secondary bridge without inrush current.

In addition to one or more of the features described herein, or as an alternative, further embodiments of the power converter circuit may include a voltage sensor.

In addition to one or more of the features described herein, or as an alternative, further embodiments of the power converter circuit may include a current sensor.

In addition to one or more of the features described herein, or as an alternative, further embodiments of the power converter circuit may include that the controller adjusts a gate signal of one or more of the first plurality of switches or the second plurality of switches relative to a common control clock, wherein adjusting the gate signal includes adjusting a gate duration of the gate signal and a relative phase of the gate signal.

In another embodiment a vehicle is provided. The vehicle includes a high voltage battery, a low voltage battery, and a power converter circuit electrically connecting the high voltage battery and the low voltage battery. The power converter circuit includes a primary bridge connected to the high voltage battery, the primary bridge having a current sensor, a voltage sensor, and a first plurality of switches including a first switch, a second switch, a third switch, and a fourth switch. The power converter circuit further includes a secondary bridge connected to the low voltage battery, the secondary bridge having a second plurality of switches including a fifth switch, a sixth switch, a seventh switch, and an eight switch. The power converter circuit further includes a transformer electrically connecting the primary bridge and the secondary bridge. The power converter circuit further includes a controller to selectively control the first plurality of switches and the second plurality of switches.

In addition to one or more of the features described herein, or as an alternative, further embodiments of the vehicle may include that the controller disables the secondary bridge by opening one or more the second plurality of switches, regulates a voltage to a desired target until a steady state is reached, responsive to the steady state being reached, enables the secondary bridge by closing the one or more of the second plurality of switches, and causes power to be transferred across the transformer from the primary bridge to the secondary bridge without inrush current.

In addition to one or more of the features described herein, or as an alternative, further embodiments of the vehicle may include that the controller adjusts a gate signal of one or more of the first plurality of switches or the second plurality of switches relative to a common control clock, wherein adjusting the gate signal includes adjusting a gate duration of the gate signal and a relative phase of the gate signal.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an illustration of a vehicle supporting architectures for high power density power conversion using a power converter circuit according to one or more embodiments;

FIG. 2 is a block diagram of a power converter circuit according to one or more embodiments;

FIG. 3A is a control block diagram of startup with a sensor in an isolation circuit according to one or more embodiments;

FIG. 3B is a control block diagram of startup without a sensor in an isolation circuit according to one or more embodiments;

FIG. 3C is a control block diagram for pre-charge of the power converter circuit according to one or more embodiments;

FIG. 4A is a flow diagram of a method for power conversion system startup for vehicles according to one or more embodiments; and

FIG. 4B is a flow diagram of a method for power conversion system startup for vehicles according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

One or more embodiments described herein provides power conversion system startup for vehicles.

The propulsion systems of existing electric vehicles (EVs), including hybrid electric vehicles (HEVs) and plug-in hybrid electric vehicles (PHEVs), use an onboard charging module to charge a battery of the vehicle from the electrical grid. Such vehicles also use an accessory power module to supply electrical power to various other systems of the vehicle, such as infotainment systems, climate control systems, and/or the like. These systems are examples of power conversion systems, which manage the transfer and transformation of energy to drive various components. Power conversion systems convert energy from sources like batteries or fuel cells into usable forms, such as converting direct current (DC) to alternating current (AC) for electric motors or regulating voltage levels for different systems. This ensures efficient energy use, supporting propulsion, charging, and onboard electronics.

In the realm of EVs, the demand for efficient and compact power conversion systems is ever-increasing. As these vehicles become more prevalent, there is a desire for high power density and efficient power conversion systems that can handle multiple functions, such as onboard charging and accessory power management. An important aspect of these systems is the startup process, which can present several challenges, particularly in resonant mode converters.

One of the issues faced by existing power conversion systems is the occurrence of large inrush currents during startup. These inrush currents can lead to significant stress on the components, potentially negatively affecting the converter and reducing the lifespan of the converter. To mitigate this problem, existing systems often resort to using components with higher voltage ratings, such as 800V rated devices, which can significantly increase the overall complexity and weight of the vehicle. Additionally, clamping circuits or other protective measures are sometimes employed, further adding to the complexity.

The use of higher-rated components not only increases complexity and weight but also limits the scalability of the system for higher power applications. Moreover, the additional protective measures can introduce inefficiencies and complicate the design, making it challenging to achieve the desired performance in a cost-effective manner. As a result, there is a need for innovative approaches that can address these issues while maintaining or improving the efficiency and reliability of the power conversion systems.

One or more embodiments described herein address these and other challenges by managing the startup of power conversion systems in vehicles to reduce or eliminate inrush current. One or more embodiments enables the use of components with half the voltage rating of the maximum voltage in the system, thereby reducing complexity without compromising performance. One or more embodiments employs a plurality of series-connected devices across a high-voltage (HV) battery, coupled to another set of switches across a low-voltage (LV) battery through an isolation network. This configuration allows for effective control of inrush currents, either through the use of sensors or sensorless control methods, ensuring a smooth and reliable startup process. By optimizing the operation of the power conversion system, one or more embodiments described herein offers an approach that enhances the overall efficiency and longevity of the vehicle's electrical systems.

One or more embodiments described herein can be applied to any suitable hybrid vehicle, such as mild hybrids, full hybrids (e.g., parallel hybrids and series hybrids), plug-in hybrids, electric vehicles with range extender hybrids, and/or the like, including combinations and/or multiples thereof.

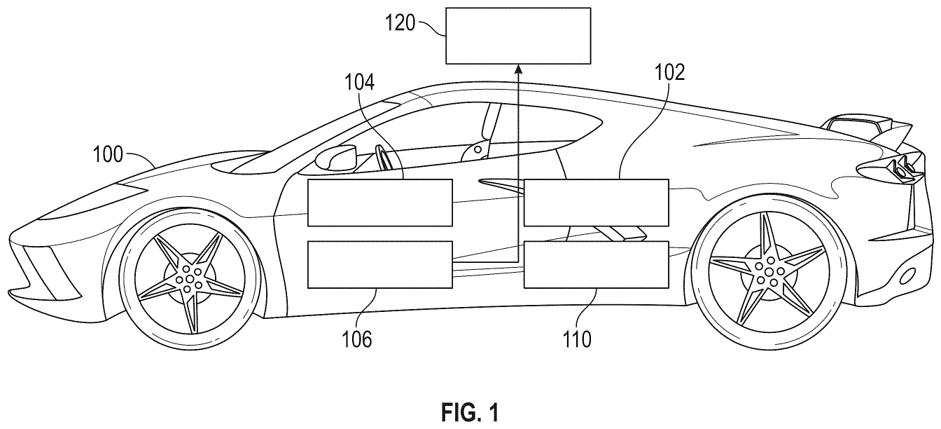

FIG. 1 is an illustration of a vehicle 100 having a power converter circuit 110 according to one or more embodiments. The vehicle 100 serves as an example platform for implementing power conversion system startup. The vehicle 100 integrates various components to facilitate these functionalities, including a controller 102, an internal combustion engine (ICE) 104, a battery 106 (which may represent one or more of a high voltage (HV) battery, a low voltage (LV) battery, and/or the like, including combinations and/or multiples thereof), and the power converter circuit 110. The vehicle 100 can be any type of automobile, such as a car, truck, van, bus, motorcycle, or boat. The vehicle 100 may be powered by gasoline, diesel, or a combination of electrical power from the battery 106 and the ICE 104, as seen in HEVs or PHEVs.

The controller 102 refers to a dedicated controller including a processor and a memory, a general controller including control modules configured to enact a control process using the dedicated controller, a network of multiple distinct controllers in communication with each other and each including processors and memory and being configured to cooperatively implement the control process, and any similar configuration for implementing the control process. The controller 102 supports implementing power conversion system startup of the power converter circuit 110.

The ICE 104 is a component of the vehicle 100, providing mechanical power that can be converted into electrical power for various applications. The ICE 104 can be fueled by gasoline, diesel, or other suitable fuels. In the context of V2V and V2L operations, the ICE 104 works in conjunction with other components (e.g., a generator and an inverter) to generate and regulate electrical power, which can be used to charge the battery 106 or supply power to external loads.

The battery 106 represents one or more batteries within the vehicle 100. The battery 106 can be a single battery, multiple batteries, or a battery system. The battery 106 receives electrical power from various sources, including external power source 120 (also referred to as “an AC source”) or an alternator or generator of the vehicle 100. The battery 106 supplies electrical power to an electric motor for vehicle propulsion, internal systems like infotainment or climate control, external systems or devices connected to the vehicle 100 (V2L operations), other vehicles connected to the vehicle 100 (e.g., V2V charging), such as an external vehicle, and/or the like, including combinations and/or multiples thereof.

The power converter circuit 110 is used to covert AC electrical power from the external power source 120 (e.g., AC source) into DC electrical power, which is supplied to the battery 106 (e.g., a low voltage (LV) battery and a high voltage (HV) battery). The power converter circuit 110 can include an OBCM, an auxiliary power module (APM), a V2L DC module, a V2L AC module and/or the like, including combinations and/or multiples thereof.

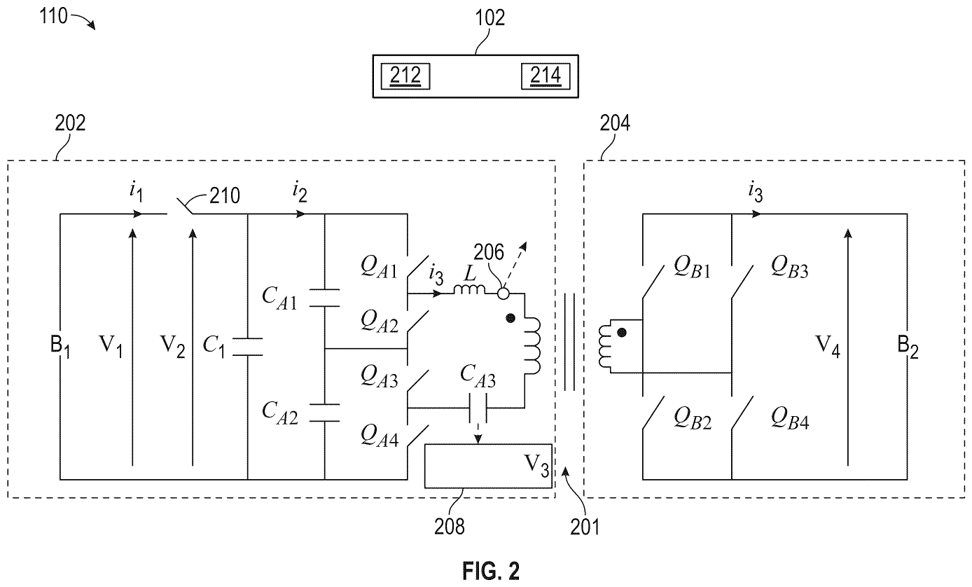

Turning now to FIG. 2, an embodiment of the power converter circuit 110 is shown in more detail and is described herein.

Aspects of the power converter circuit 110 are controlled by the controller 102. The controller 102 is responsible for managing power conversion of the power converter circuit 110 within the vehicle 100 using a transformer 201. The transformer 201 converts electrical power from a first voltage to a second voltage different than the first voltage. The transformer 201 may be a direct current (DC) to DC converter according to one or more embodiments.

The controller 102 includes a processor 212 and a memory 214, which store and execute computer-readable instructions to control the switches of the power converter circuit 110. The controller 210 communicates with other components (e.g., the battery 106, the ICE 104, the external power source 120, and/or the like, including combinations and/or multiples thereof) to adjust the switches. According to one or more embodiments, the controller 102 can be a microcontroller, digital signal processor (DSP), ASIC, field programmable gate array (FPGA), and/or the like, including combinations and/or multiples thereof.

The processor 212 within the controller 210 executes the instructions stored in the memory 214 to perform various operations related to power conversion. The processor 212 processes data and signals from other components to determine an operating mode of the vehicle (e.g., driving, charging, etc.). The processor 212 can be one or more devices that can be implemented using various types of hardware, such as microcontrollers, application-specific integrated circuits (ASICs), field-programmable gate arrays (FPGAs), system-on-a-chip (SOC), and/or the like, including combinations and/or multiples thereof.

The memory 214 stores the computer-readable instructions that the processor 212 executes. The memory 214 may also store data related to power conversion, such as voltage and current levels, state of charge (SOC) of the battery 106, and other relevant parameters. The memory 214 enables the controller 210 to perform the functions of the controller 210 effectively by providing the desired instructions and data storage capabilities. The memory 214 can be one or more devices that can implement various types of storage hardware, such as flash memory, random-access memory, read-only memory, and/or the like, including combinations and/or multiples thereof.

With continued reference to FIG. 2, the power converter circuit 110 employs a first plurality of components (e.g., switches, capacitors, sensors, inductors, and/or the like, including combinations and/or multiples thereof) across a HV battery and coupled to a second plurality of components (e.g., switches) across a LV battery through an isolation network with a current sensor 206 in series in the isolation network in a vehicle (e.g., the vehicle 100).

The first plurality of series connected components are arranged to form a primary bridge 202, and the second plurality of components are arranged to form a secondary bridge 204. The primary bridge 202 includes or is connected to a first battery (“Battery1” or “B1”), which may be a relatively high voltage battery (e.g., substantially 400v to substantially 800v), and the secondary bridge 204 includes or is connected to a second battery (“Battery2” or “B2”), which may be a relatively low voltage battery (e.g., substantially 12v to substantially 15v).

The primary bridge 202 includes capacitors C₁, C_{A1}, C_{A2}, and C_{A3}, inductor L, and switches Q_{A1}, Q_{A2}, Q_{A3}, Q_{A4}, which are series connected switches configured and arranged as shown. The secondary bridge 204 includes switches Q_{B1}, Q_{B2}, Q_{B3}, Q_{B4} configured and arranged as shown. The switches Q_{A1}, Q_{A2}, Q_{A3}, Q_{A4}, Q_{B1}, Q_{B2}, Q_{B3}, Q_{B4} are selectively controllable by the controller 102 such that each of the switches can be opened (disabled) or closed (enabled).

A current sensor 206 and/or a voltage sensor 208 can be arranged as shown in FIG. 2 to sense or measure the current (i₃) and/or voltage (v₃) respectively in the primary bridge 202. According to one or more embodiments, the voltage sensor is arranged across a capacitor in series in the primary bridge 202 as shown.

According to one or more embodiments, the controller 102 delays operation of one of the bridges (e.g., the secondary bridge 204) relative to the other of the bridges (e.g., the primary bridge 202) by adjusting one or more of the switches Q_{A1}, Q_{A2}, Q_{A3}, Q_{A4}, Q_{B1}, Q_{B2}, Q_{B3}, Q_{B4}. According to one or more embodiments, the controller 102 adjusts the gate signals of one or more of the switches Q_{A1}, Q_{A2}, Q_{A3}, Q_{A4}, Q_{B1}, Q_{B2}, Q_{B3}, Q_{B4} relative to a common control clock. For example, the controller 102 can adjust a gate duration and a relative phase of the gate signals simultaneously or sequentially. According to one or more embodiments, the controller 102 controls a transformer current of the transformer 201 using the current sensor 206 and/or using the voltage sensor 208. According to one or more embodiments, a peak transformer current is regulated by the controller 102, such as by regulating an effective voltage value (or “root-mean-square” (RMS) value) of the transformer 201.

According to one or more embodiments, the controller 102 controls the inrush of current from the HV battery (e.g., battery1) to the LV battery (e.g., battery2) using the following approach. First, the controller 102 disables the secondary bridge 204 by opening the switches Q_{B1}, Q_{B2}, Q_{B3}, Q_{B4}. Next, the controller 102 regulates the voltage V3 (or integral of the current i3) to a desired target until a steady state is reached. One the steady state is reached, the controller 102 enables the secondary bridge 204 by closing one or more of the switches Q_{B1}, Q_{B2}, Q_{B3}, Q_{B4}. Finally, power is transferred from the primary bridge 202 to the secondary bridge 204 (or vice versa), which enables power transfer without inrush current at the batteries battery1 or battery2.

According to one or more embodiments, the secondary bridge 204 can be operated in such a way that enables current-mode control within the resonant network. This can be done without sensors (e.g., without the current sensor 206 and/or the voltage sensor 208) by sequencing the bridges and modulating the gates in a pattern that is not suitable for steady state operation. In such cases, the secondary bridge 204 may be inactive

According to one or more embodiments, the startup sequence for the secondary bridge 204 considers the primary bridge 202. For example, the primary bridge 202 appears in parallel with a resonant tank (not shown) and takes more time to pre-charge. A blocking cap voltage oscillates around a DC value, and the transformer current is limited (e.g., reactive power).

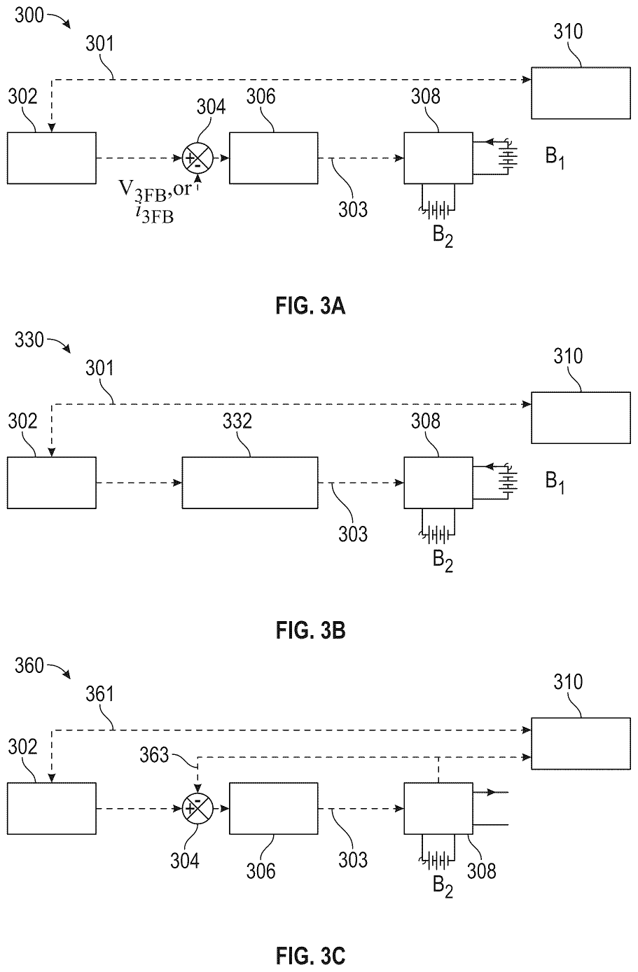

FIGS. 3A, 3B, and 3C depict control block diagrams 300, 330, and 360, respectively, for implementing control functionality of the power converter circuit 110. That is, the control block diagrams 300, 330, 360 can be used to control the power converter circuit 110.

FIG. 3A is a control block diagram 300 of startup with a sensor in an isolation circuit according to one or more embodiments. The startup begins with a power transfer request 301 from a vehicle controller 310, which initiates the startup process. The vehicle controller 310 is a controller, such as an electronic control unit (ECU) that oversees various systems and components within the vehicle 100, such as the coordination of power converter circuit 110 to ensure efficient and safe power transfer in the vehicle.

The power transfer request 301 is processed by a regulator 302, which adjusts the control system's parameters to meet the desired power transfer requirements. The output of the regulator 302 (e.g., V3ref or i3ref) acts as a reference signal and is added to a feedback signal (e.g., V3_{FB} or i_{3FB}) at summing point 304. The feedback signal is the signal received from the voltage sensor 208 and/or current sensor 206 of FIG. 2.

A controller 306, which is an example of the controller 102, receives the output of the summing point 304, which combines various input signals as described. This feedback allows the controller 306 to make real-time adjustments, optimizing the performance of the power converter circuit 110, by generating a command signal 303. The command signal 303 commands (e.g., using commands u_{A1}, u_{A2}, u_{A3}, u_{A4}, u_{B1}, u_{B2}, u_{B3}, u_{B4}) the switches shown in FIG. 2 (e.g., switches Q_{A1}, Q_{A2}, Q_{A3}, Q_{A4}, Q_{B1}, Q_{B2}, Q_{B3}, Q_{B4}) to be opened (disabled) or closed (enabled). The command signal 303 causes a DC/DC converter 308 to convert the electrical power to the appropriate voltage and current levels desired for Battery1 and Battery2.

The DC/DC converter 308 interfaces with the two batteries, Battery1 and Battery2, which represent the high-voltage and low-voltage batteries in the vehicle, respectively. The DC/DC converter 308 manages the flow of power between these batteries using the switches, ensuring that the vehicle's electrical systems are adequately powered. Additionally, the vehicle controller 310 oversees the entire process, coordinating the actions of the various components to achieve the desired power transfer. This control block diagram 300 illustrates the complex interactions between the different elements of the power converter circuit 110, highlighting the importance of precise control and coordination in achieving efficient power management.

FIG. 3B is a control block diagram 330 of startup without a sensor in an isolation circuit according to one or more embodiments. In this example, the voltage sensor 208 and/or the current sensor 206 of FIG. 2 are not used. Instead, the regulator 302 sends the reference voltage or current to a lookup table (LUT) or state machine 332, which generates the command signal 303, and the DC/DC converter 308 implements the command signal 303.

FIG. 3C is a control block diagram 360 for pre-charge of the power converter circuit according to one or more embodiments. In this example, the vehicle controller 310 sends a pre-charge request 361 to the regulator 302 and a feedback signal 363 to the summing point 304. The controller 306 generates the command signal 303 based on the output of the summing point 304.

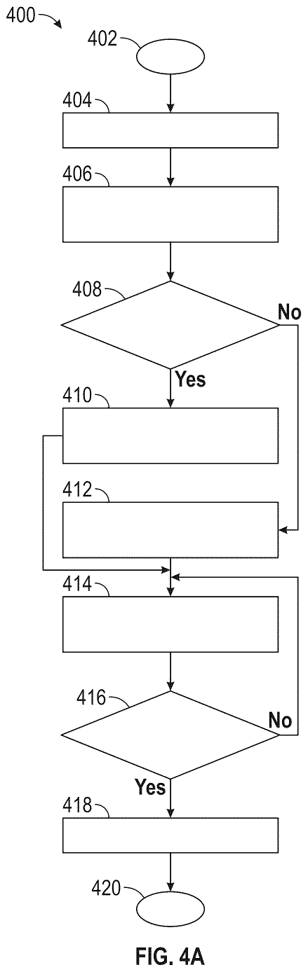

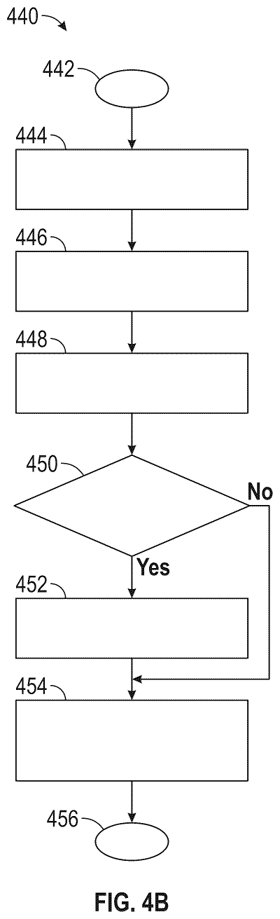

FIG. 4A illustrates a flow diagram of a method 400 for conversion system startup for vehicles according to one or more embodiments. The method 400 can be implemented by any suitable system or device, such as the controller 102 of FIGS. 1 and 2.

The method 400 begins with operation 402. At operation 404, all switches in the power converter circuit 110 are disabled to ensure a safe starting condition. This prevents any unintended current flow.

Following the disabling of switches, operation 406 involves determining and enabling a primary bridge, such as the primary bridge 202 of FIG. 2. This operation is useful for establishing the initial path for current flow, setting the stage for controlled startup of the power converter circuit 110.

Operation 408 assesses whether an HV pre-charge is needed. An HV pre-charge is considered needed when a high voltage is applied across a capacitance with voltage potential that is substantially lower than the voltage source. If pre-charging is required (operation 408 “Yes”), the method 400 proceeds to operation 410, where the duration of control signals is regulated to manage the pre-charge process. This regulation is useful to ensure that the voltage levels are brought up gradually, minimizing the risk of inrush currents that could damage the system. If no HV pre-charge is needed (operation 408 “No”), the method 400 advances to operation 412, where the duration of control signals is initialized. This operation sets the baseline for subsequent operations, ensuring that the control signals are appropriately timed for the power converter circuit 110.

Operation 414 then involves regulating a desired relative clock, which synchronizes the control signals with the power converter circuit 110's operational timing, further aiding in the smooth startup of the power converter circuit 110.

The method 400 continues with operation 416, which checks if the pre-charge is complete. If the pre-charge is not yet complete (operation 416 “No”), the method 400 loops back to continue regulating the control signals at operation 414.

Once the pre-charge is confirmed as complete (operation 416 “Yes”), operation 418 disables the primary bridge, transitioning the power converter circuit 110 to a steady operational state. Finally, operation 420 marks the end of the startup process, indicating that the power converter circuit 110 is ready for normal operation. The method 400 provides a controlled and efficient startup, reducing the risk of component stress and enhancing the overall reliability of the vehicle's power conversion system.

Additional processes also may be included, and it should be understood that the process depicted in FIG. 4A represents an illustration, and that other processes may be added or existing processes may be removed, modified, or rearranged without departing from the scope of the present disclosure. It should also be understood that the processes depicted in FIG. 4A may be implemented as programmatic instructions stored on a non-transitory computer-readable storage medium that, when executed by a processor (e.g., the processor 212 of FIG. 2) of a computing system (e.g., the controller 102 of FIGS. 1 and 2), cause the processor to perform the processes described herein.

FIG. 4B illustrates a flow diagram of a method 440 for conversion system startup for vehicles according to one or more embodiments. The method 440 can be implemented by any suitable system or device, such as the controller 102 of FIGS. 1 and 2.

The method 440 begins with operation 442. At operation 444, a power transfer request is received. This initial step sets the stage for the subsequent operations, ensuring that the power converter circuit 110 is prepared to handle the requested power transfer efficiently.

Following the receipt of the power transfer request, operation 446 involves initializing the duration of control signals. This step is useful for establishing the timing parameters that will govern the operation of the power converter circuit 110's components during the power transfer. Proper initialization ensures that the control signals are aligned with the system's requirements, facilitating a smooth transition.

Operation 448 proceeds with initializing a relative clock for the control signals. This operation synchronizes the control signals with the power converter circuit 110's operational timing, ensuring that the components work in synchronization during the power transfer. The relative clock serves as a reference point, helping to coordinate the actions of various system elements.

The method 440 then moves to operation 450, which determines whether to perform inrush current control (e.g., when excessive current may cause damage to electronics/components). If inrush current control to be performed (operation 450 “Yes”), the method 440 advances to operation 452, where the duration of control signals is regulated to manage the inrush current effectively. This regulation is useful to prevent excessive current flow. Subsequent to completing operation 452, or if inrush control is deemed unnecessary (operation 450 “No”), the method 440 proceeds to operation 454.

In operation 454, the method 440 regulates a desired relative clock of control signals, further refining the synchronization of the power converter circuit 110's operations. This operation provides for precisely timing the control signals to maintain system stability and efficiency during the power transfer. Finally, operation 456 marks the end of the method 440, indicating that the power converter circuit 110 is ready for operation. The method 440 provides a structured approach to managing power transfer in the power converter circuit 110, enhancing reliability and reducing the risk of component stress.

Additional processes also may be included, and it should be understood that the process depicted in FIG. 4B represents an illustration, and that other processes may be added or existing processes may be removed, modified, or rearranged without departing from the scope of the present disclosure. It should also be understood that the processes depicted in FIG. 4B may be implemented as programmatic instructions stored on a non-transitory computer-readable storage medium that, when executed by a processor (e.g., the processor 212 of FIG. 2) of a computing system (e.g., the controller 102 of FIGS. 1 and 2), cause the processor to perform the processes described herein.

It should be appreciated that the functioning of any vehicle implementing one or more of the embodiments described herein is improved. More particularly, one or more embodiments described herein offer significant benefits and advantages, particularly in preventing inrush current. For example, the power converter circuit 110 offers several improvements and technical benefits that enhance the functioning of vehicles implementing its design. One of the advantages is the effective management of inrush current during the startup process. By employing a configuration that includes a plurality of series-connected devices across a high-voltage battery and a set of switches across a low-voltage battery, the circuit can control inrush currents either through sensor-based or sensorless methods (e.g., the methods 400, 440 of FIGS. 4A, 4B respectively). This capability reduces the stress on components, thereby preventing potential damage and extending the lifespan of the converter.

Additionally, the power converter circuit 110 allows for the use of components with lower voltage ratings, approximately half of the maximum system voltage. This reduction in component rating leads to significant weight savings and reduced complexity, as it enables the use of lighter weight components without compromising performance. The power converter circuit 110's design also simplifies the overall system architecture, reducing complexity and weight, which are critical factors in vehicle design.

Furthermore, the power converter circuit 110 enhances the efficiency and reliability of the vehicle's electrical systems by optimizing power transfer between high-voltage and low-voltage batteries. This optimization ensures that the vehicle's electrical systems are adequately powered, supporting various functions such as propulsion, charging, and onboard electronics. Overall, the power converter circuit 110 provides an effective and efficient solution for managing power conversion in modern vehicles, contributing to improved vehicle performance and longevity.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the essential scope thereof. Therefore, it is intended that the present disclosure is not limited to the particular embodiments disclosed, but will include all embodiments falling within the scope thereof.

1. A method comprising:
providing a power converter circuit comprising a primary bridge having a first plurality of switches and a secondary bridge having a second plurality of switches;
disabling the secondary bridge of the power converter circuit by opening one or more of the second plurality of switches;
enabling the primary bridge by closing one or more of the first plurality of switches to establish an initial path for current flow;
determining whether a high-voltage pre-charge is to be performed, wherein the high-voltage pre-charge is to be performed when a high voltage is applied across a capacitance with voltage potential that is substantially lower than a voltage source;
responsive to determining that the high-voltage pre-charge is to be performed, regulating a duration of control signals to manage a pre-charging process;
regulating a desired relative clock for the control signals;
determining whether the high-voltage pre-charge is complete;
responsive to determining that the high voltage pre-charge is complete, disabling the primary bridge by opening one or more of the first plurality of switches;
regulating a voltage to a desired target until a steady state is reached;
responsive to the steady state being reached, enabling the secondary bridge by closing the one or more of the second plurality of switches; and
transferring power from the primary bridge to the secondary bridge without inrush current.

2. The method of claim 1, wherein the primary bridge is a high voltage bridge that includes or is electrically connected to a high voltage battery.

3. The method of claim 2, wherein the secondary bridge is a low voltage bridge that includes or is electrically connected to a low voltage battery.

4. The method of claim 1, wherein the first plurality of switches comprises four switches arranged in series.

5. The method of claim 1, wherein the second plurality of switches comprises four switches.

6. The method of claim 1, wherein the power converter circuit comprises a voltage sensor.

7. The method of claim 1, wherein the power converter circuit comprises a current sensor.

8. The method of claim 1, further comprising adjusting a gate signal of one or more of the first plurality of switches or the second plurality of switches relative to a common control clock.

9. The method of claim 8, wherein adjusting the gate signal comprises adjusting a gate duration of the gate signal.

10. The method of claim 8, wherein adjusting the gate signal comprises adjusting a relative phase of the gate signal.

11. The method of claim 1, further comprising controlling a transformer current of a transformer using a current sensor of the power converter circuit.

12. The method of claim 1, further comprising controlling a transformer current of a transformer using a voltage sensor of the power converter circuit.

13. The method of claim 1, further comprising regulating an effective voltage value of a transformer.

14. A power converter circuit for a vehicle, the power converter circuit comprising:
a primary bridge having a first plurality of switches comprising a first switch, a second switch, a third switch, and a fourth switch;
a high voltage battery electrically connected to the primary bridge;
a secondary bridge having a second plurality of switches comprising a fifth switch, a sixth switch, a seventh switch, and an eighth switch;
a low voltage battery electrically connected to the secondary bridge;
a transformer electrically connecting the primary bridge and the secondary bridge; and
a controller to selectively control the first plurality of switches and the second plurality of switches, the controller:
causes the secondary bridge to be enabled by causing one or more of the second plurality of switches to open;
enables the primary bridge by closing one or more of the first plurality of switches to establish an initial path for current flow;
determines whether a high-voltage pre-charge is to be performed, wherein the high-voltage pre-charge is to be performed when a high voltage is applied across a capacitance with voltage potential that is substantially lower than a voltage source;
responsive to determining that the high-voltage pre-charge is to be performed. regulates a duration of control signals to manage a pre-charging process;
regulates a desired relative clock for the control signals;
determines whether the high-voltage pre-charge is complete;
responsive to determining that the high voltage pre-charge is complete, disables the primary bridge by opening one or more of the first plurality of switches;
regulates a voltage to a desired target until a steady state is reached;
responsive to the steady state being reached, causes the secondary bridge to be enabled by causing the one or more of the second plurality of switches to close; and
causes power to be transferred across the transformer from the primary bridge to the secondary bridge without inrush current.

15. The power converter circuit of claim 14, further comprising a voltage sensor.

16. The power converter circuit of claim 14, further comprising a current sensor.

17. The power converter circuit of claim 14, wherein the controller adjusts a gate signal of one or more of the first plurality of switches or the second plurality of switches relative to a common control clock, wherein adjusting the gate signal comprises adjusting a gate duration of the gate signal and a relative phase of the gate signal.

18. A vehicle comprising:
a high voltage battery;
a low voltage battery; and
a power converter circuit electrically connecting the high voltage battery and the low voltage battery, the power converter circuit comprising:
a primary bridge connected to the high voltage battery, the primary bridge having a current sensor, a voltage sensor, and a first plurality of switches comprising a first switch, a second switch, a third switch, and a fourth switch;
a secondary bridge connected to the low voltage battery, the secondary bridge having a second plurality of switches comprising a fifth switch, a sixth switch, a seventh switch, and an eighth switch;
a transformer electrically connecting the primary bridge and the secondary bridge; and
a controller to selectively control the first plurality of switches and the second plurality of switches, wherein, during a pre-charge mode of the power converter circuit, the controller is configured to receive an output of a summing point that combines a reference signal generated by a regulator responsive to a pre-charge request with a feedback signal corresponding to a voltage and/or current of the power converter circuit, and to generate, based on the output of the summing point, a command signal that commands switches of the first plurality of switches and the second plurality of switches to be opened or closed during the pre-charge mode.

19. The vehicle of claim 18, wherein the controller:
disables the secondary bridge by opening one or more of the second plurality of switches;
enables the primary bridge by closing one or more of the first plurality of switches to establish an initial path for current flow;
determines whether a high-voltage pre-charge is to be performed, wherein the high-voltage pre-charge is to be performed when a high voltage is applied across a capacitance with voltage potential that is substantially lower than a voltage source;
responsive to determining that the high-voltage pre-charge is to be performed, regulates a duration of control signals to manage a pre-charging process;
regulates a desired relative clock for the control signals;
determines whether the high-voltage pre-charge is complete;
responsive to determining that the high voltage pre-charge is complete, disables the primary bridge by opening one or more of the first plurality of switches;
regulates a voltage to a desired target until a steady state is reached;
responsive to the steady state being reached, enables the secondary bridge by closing the one or more of the second plurality of switches; and
causes power to be transferred across the transformer from the primary bridge to the secondary bridge without inrush current.

20. The vehicle of claim 18, wherein the controller adjusts a gate signal of one or more of the first plurality of switches or the second plurality of switches relative to a common control clock, wherein adjusting the gate signal comprises adjusting a gate duration of the gate signal and a relative phase of the gate signal.
